(19) United States
(12) Patent Application Publication
(10) Pub. No.: US 2022/0144704 A1
(43) Pub. Date: May 12, 2022

(54) CONCRETE STRUCTURES FORMED USING AN ELASTIC DESIGN METHOD WITH MODULUS OF RUPTURE TESTING

(71) Applicant: Pensmore Reinforcement Technologies, LLC, Ann Arbor, MI (US)

(72) Inventor: Luke Pinkerton, Ann Arbor, MI (US)

(21) Appl. No.: 17/432,515

(22) PCT Filed: Mar. 19, 2020
(86) PCT No.: PCT/US2020/023490

§ 371 Date: Aug. 20, 2021

Related U.S. Application Data
(60) Provisional application No. 62/822,250, filed on Mar. 22, 2019.

(51) Int. Cl. C04B 28/02; C04B 40/00; C04B 20/02; C04B 20/00

(52) U.S. Cl. CPC C04B 28/02; C04B 20/0048; C04B 20/026; C04B 40/0046

(57) ABSTRACT

A process for forming a concrete structure that exhibits an increased modulus of rupture (MOR) and/or enhanced consistency of the associated coefficient of variation (COV) without increasing the cement content or decreasing the water to cement ratio in the cement mixture. The process provides a cost effective means of improving flextural tensile strength of the concrete structure.

This disclosure relates generally to cementitious building materials used in the design and formation of concrete structures. More specifically, this disclosure relates to a method of mixing cementitious building materials that provides the performance necessary to meet or exceed conventional linear elastic design norms associated with structural plain concrete structures.

The statements in this section merely provide background information related to the present disclosure and may not constitute prior art. Structural plain concrete is described in ACI 318-14 guide, Chapter 14 (American Concrete Institute, Farmington Hills, Mich.). Similar concepts are employed in ACI 332-14 guide for residential walls. In addition, plain concrete methods are employed in slab on grade design in ACI 360-10 guide. The structural plain concrete sections allow use of plain concrete in members in buildings and non-building structures. This includes slabs, soil-supported structures, arches, walls and pedestals. Design is done elastically using a tensile and shear capacity based on conservative relationship between the compressive strength of the concrete and these properties. A conservative resistance factor derived first 1950's is applied to the designs. The American Concrete Institute in ACI 360, as well as the Portland Cement Association (Farney, J A, 2001), publish guides for slab on grade construction that rely on modulus of rupture for design on plain concrete slabs. ACI 318-14, 332-14 and ACI 360 all prescribe that modulus of rupture (MOR) be defined in terms of correlations to compressive strength. Thus, the MOR of concrete may be defined as the concrete's resistance to bending stresses.

The basic approaches as described in ACI 322 guide were developed in the 1970's to allow for design based on modulus of rupture. The provisions were later removed from the code and there has been little work in this area since. There has, however, been significant development in products that can enhance the properties of plain concrete. Thus, alternative methods of design and analysis are desired in order to provide approaches that will allow ready-mix concrete producers to develop performance mixes that can be used to reduce the requirement for traditional reinforcement in a variety of applications.

### SUMMARY

The present disclosure generally provides a process for the mixing design of a cement mixture for use in forming a concrete structure. This process comprises providing a cement paste comprising a mixture of water and cement; providing one or more aggregates having an outer surface; mixing the aggregates with the cement paste to form the cement mixture; and using the cement mixture to form the concrete structure. The flexural tensile strength measured as the Modulus of Rupture according to ASTM C78 or the associated coefficient of variation at 28 days for this concrete structure is enhanced over the flexural tensile strength or coefficient of variation measured for an identical conventional concrete structure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flowchart of a process for the mixing design of a cement mixture used to form a concrete structure according to the teachings of the present disclosure; and

FIG. 2 is a plot comparing the modulus of rupture (MOR) and the coefficient of variation (COV) for plain concreate and twisted steel micro-reinforcements (TSMR) load deflection to peak according to ASTM C78 (ASTM International, West Conshohocken, Pa.).

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally provides a process for the mixing design of a cement mixture for use in forming a concrete structure that exhibits a flexural tensile strength measured as the Modulus of Rupture (MOR) according to ASTM C78 or the associated coefficient of variation (COV) at 28 days for this concrete structure is enhanced over the flexural tensile strength or coefficient of variation measured for an identical conventional concrete structure.

For the purpose of this disclosure the terms “about” and “substantially” are used herein with respect to measurable values and ranges due to expected variations known to those skilled in the art (e.g., limitations and variability in measurements).

Furthermore, any range in parameters that is stated herein as being “between [a 1^{st} number] and [a 2^{nd} number]” or “between [a 1^{st} number] to [a 2^{nd} number]” is intended to be inclusive of the recited numbers. In other words, the ranges are meant to be interpreted similarly as to a range that is specified as being “from [a 1^{st} number] to [a 2^{nd} number]”.

Increases in modulus of rupture (MOR) are possible through the use of, without limitation, chemical admixtures, fibers, engineered aggregates, and special types of cement. The process of the present disclosure provides a simple path for designers to characterize concrete performance through standard testing and modify the tensile capacity and resistance factor in order to allow the benefit in concrete structures formed therefrom while still providing the required structural reliability.

At a more fundamental level, the modulus of elasticity of the course aggregates is correlated to the MOR. The failure in plain concrete may occur at the interface between the paste and the aggregate due to the mismatch in stiffness between the paste and aggregate. If the stiffness of the aggregate is higher, it more closely approaches the stiffness of the paste, thereby delaying failure at this critical interface.

The creation of a performance based alternative approach for designing and/or forming plain concrete structures would allow engineers to use existing and new technologies to their advantage, as well as create a competitive market focused on actually improving the elastic tensile behavior of concrete. With the advent of nanotechnology, for example, it is no longer inconceivable that concrete tensile capacity could actually approach its compressive strength. The adoption of a performance-based approach may pave the way for the industry to capitalize on the economy, simplicity of construction, and the safety that such materials could offer now and in the future.

The modulus of rupture (MOR) may also be used in deflection calculations. The ACI 318-14 guide uses a higher value for deflection than for structural plain concrete. The ACI 318-14 guide provides equations for computing deflection in Chapter 22 with the Modulus or Rupture being defined according to Equation 19.2.3.1. There is potential value in computing deflection using a performance-based approach (e.g., potential to in-crease cracking moment and the effective moment of inertia using the mean values for MOR as determined in this guide).

With increasing costs of steel, tariffs and competition from non-concrete building materials such as wood and masonry block and concerns over the environment, the concrete industry must respond in a positive manner. The performance-based approach of the present disclosure allows the concrete industry to take full advantage of materials available now and would encourage the market to develop new innovative materials making concrete more competitive in the marketplace.

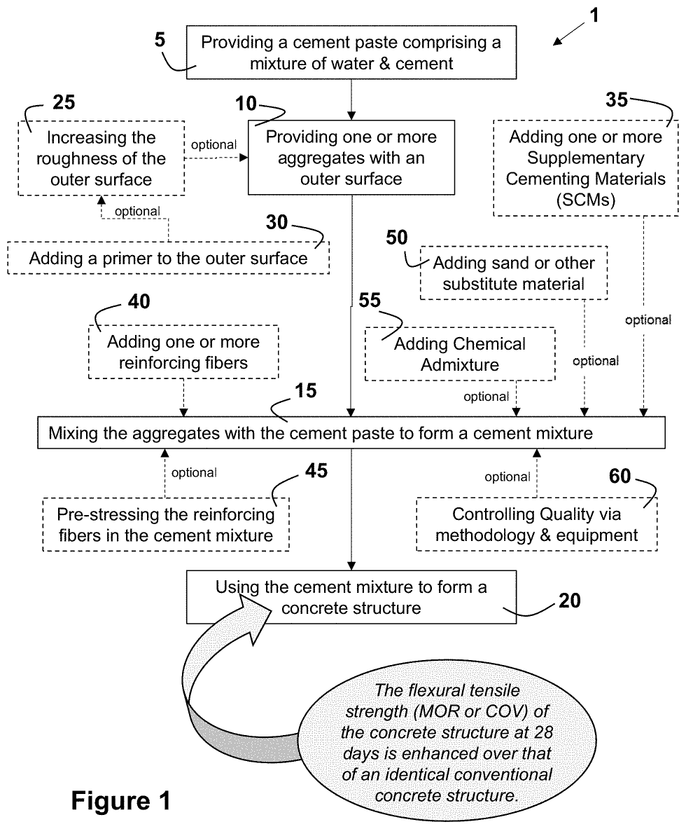

Referring now to FIG. 1, the process 1 of the present disclosure, generally comprises the steps of: providing 5 a cement paste comprising a mixture of water and cement; providing 10 one or more aggregates having an outer surface; mixing 15 the aggregates with the cement paste to form the cement mixture; and using 20 the cement mixture to form the concrete structure. The resulting concrete structure exhibits a flexural tensile strength measured as the Modulus of Rupture according to ASTM C78 or the associated coefficient of variation at 28 days that is enhanced over the flexural tensile strength or coefficient of variation measured for an identical conventional concrete structure. The enhanced flexural tensile strength or coefficient of variation is accomplished without reducing the ratio of water to cement in the cement paste or the increasing the cementitious content of the cement mixture.

A conventional concrete structure may be defined as a structure formed from a cement mixture that comprises aggregates whose outer surface has not been modified by increasing the roughness or adding a primer or a formed from a cement mixture in which one or more reinforcing fibers incorporated into said mixture has not been pre-stressed by any means known to one skilled in the art. A conventional concrete structure may further be defined as lacking not including the addition of sand or another substitute material or a chemical admixture that is capable of increasing the interfacial bonding between the cement paste and the aggregates and/or reinforcing fibers The increased bonding may include providing elasticity in the interfacial zone between the aggregates and/or reinforcing fibers and the cement paste.

According to another aspect of the present disclosure, the process 1 may further comprise increasing 25 the roughness of the outer surface of the aggregates. Increasing the roughness of the aggregates may enhance the interfacial bond between the cement paste and the aggregates. The roughness of the outer surface of the aggregates may be increased by etching, embossing, scratching or similar method. When desirable, the process 1 may also comprise the addition 30 of an agent in the form of a primer to the outer surface of at least one aggregate in order to facilitate the bonding of the cement paste to the aggregates.

Still referring to FIG. 1, the aggregates 10 may generally comprise a blend of different aggregate sizes and/or different aggregate types. The cement mixture may also include 35 one or more Supplementary Cementing Materials (SCMs). In addition, the process 1 may also comprise adding 40 one or more reinforcing fibers to the cement mixture. These reinforcing fibers are generally stiffer than the concrete structure, are stronger in tensile strength than the concrete structure, and exhibit continuous deformation, and/or enhance the bond strength between the cement paste and the aggregates. When desirable, the reinforcing fibers may be twisted fibers that have a polygonal cross-section. The reinforcing fibers may be pre-stressed 55 when in the cement mixture in order to enhance the MOR or COV of the resulting concrete structure.

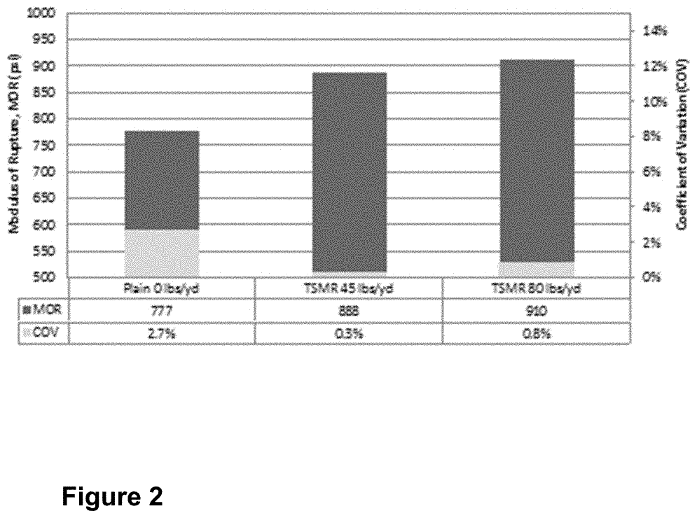

Referring now to FIG. 2, a plot is provided that compares the modulus of rupture (MOR) and the coefficient of variation (COV) for plain concreate and twisted steel micro-reinforcements (TSMR) load deflection to peak according to ASTM C78 (ASTM International, West Conshohocken, Pa.). In this figure, a conventional concrete structure is shown to exhibit a MOR of 777 psi with a COV of 2.7%, while a concrete structure comprising 45 lbs/yd of TSMR or 80 lbs/yd exhibits a MOR of about 900 psi, alternatively, at least 850 psi, alternatively, between about 875 psi and 925 psi with a COV that is about 0.3%; alternatively, between 0.3% and 0.8%.

Referring once again to FIG. 1, the process 1 may further comprise adding 50 sand or similar substitute material that increases the interfacial bonding between the cement paste and the aggregates and/or reinforcing fibers. The process 1 may also include adding 55 a chemical admixture that enhances the bond between the cement paste and the aggregate by providing elasticity in the interfacial zone therebetween. The elasticity provided by the chemical admixture may reduce any mismatch in stiffness and allow for more efficient load transfer from the cement paste to the aggregates and/or reinforcing fibers. When desirable, the process 1 may also include controlling 60 the quality of the cement mixture through the use of quality control methodology and equipment relative to the mixing of the concrete paste and the aggregates.

According to another aspect of the present disclosure a concrete structure is provided that may be formed according to the process described above and in FIG. 1.

Further embodiments that may be incorporated as part of the teachings of this disclosure are provided in Attachments A and B, the entire contents are included as part of this disclosure. In addition, the following bulleted listing of features further describe the disclosure:
a. A process or mix design that improves the concrete flexural tensile strength (Modulus of Rupture as measured by ASTM C78) or its coefficient of variation at 28 days without reducing the water cement ratio of the concrete or the increasing the cementitious content of the mix.
b. A process that provides the desired performance of the concrete structure whereby a process is applied to the aggregates that increases the roughness of the surface to improve the interfacial bond between the cement paste and the aggregate or prestresses the reinforcing fibers in the cement mixture during or prior to the formation of the concrete structure.
c. Any agent that when added to the aggregates acts a primer that improves the bond of ordinary portland cement paste to the aggregate and/or fibers.
d. A reinforcing fiber that is stiffer than the concrete structure and stronger in tensile strength than the concrete structure with continuous deformation and bond strength high enough that when added to the concrete it provides the desired performance.
e. A substitute for conventional sand that improves the interfacial bond between the cement paste and coarse aggregate and/or fibers.
f. A chemical admixture that enhances the bond between the cement paste and the aggregate by providing elasticity in interfacial zone as to reduce any mismatch in stiffness and allow more efficient load transfer from paste to aggregate or fibers.
g. A process control method that controls the quality of the concrete mix as to keep minimize the coefficient of variation in the modulus of Rupture.
h. A mixing procedure that that controls the quality of the concrete mix as to keep minimize the coefficient of variation in the modulus of Rupture.
i. A special type of mixer that controls the quality of the concrete mix as to keep minimize the coefficient of variation in the modulus of Rupture.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A process for the mixing design of a cement mixture for use in forming a concrete structure, the process comprising
providing a cement paste comprising a mixture of water and cement;
providing one or more aggregates having an outer surface;
mixing the aggregates with the cement paste to form the cement mixture; and
using the cement mixture to form the concrete structure;
wherein the concrete flexural tensile strength measured as the Modulus of Rupture according to ASTM C78 or the associated coefficient of variation at 28 days for the concrete structure is enhanced over the flexural tensile strength or coefficient of variation measured for an identical conventional concrete structure.

2. The process according to claim 1, wherein the enhanced flexural tensile strength or coefficient of variation is accomplished without reducing the ratio of water to cement in the cement paste or the increasing the cementitious content of the cement mixture.

3. The process according to claim 1, wherein the process further comprises increasing the roughness of the outer surface of the aggregates.

4. The process according to claim 3, where the roughness of the aggregates increases the interfacial bond between the cement paste and the aggregates.

5. The process according to claim 3, wherein the roughness of the outer surface of the aggregates is increased by etching, embossing, scratching or similar method.

6. The process according to claim 1, wherein the process further comprises the addition of an agent in the form of a primer to the outer surface of at least one aggregate in order to facilitate the bonding of the cement paste to the aggregates.

7. The process according to claim 1, wherein the aggregates comprise a blend of different aggregate sizes and/or different aggregate types.

8. The process according to claim 1, wherein the cement mixture further comprises one or more Supplementary Cementing Materials (SCMs).

9. The process according to claim 1, wherein the process further comprises adding one or more reinforcing fibers to the cement mixture;
wherein the reinforcing fibers are stiffer than the concrete structure, are stronger in tensile strength than the concrete structure and exhibit continuous deformation, and/or enhance the bond strength between the cement paste and the aggregates.

10. The process according to claim 9, wherein the reinforcing fibers are twisted fibers that have a polygonal cross section.

11. The process according to claim 9, wherein the process further comprises pre-stressing the reinforcing fibers in the cement mixture.

12. The process according to claim 1, wherein the process further comprises adding sand or similar substitute material that increases the interfacial bonding between the cement paste and the aggregates and/or reinforcing fibers.

13. The process according to claim 1, wherein the process further comprises adding a chemical admixture that enhances the bond between the cement paste and the aggregate by providing elasticity in the interfacial zone therebetween.

14. The process according to claim 13, wherein the elasticity provided by the chemical admixture reduces any mismatch in stiffness and allows for more efficient load transfer from the cement paste to the aggregates and/or reinforcing fibers.

15. The process according to claim 1, wherein the process further comprises controlling the quality of the cement mixture through the use of quality control methodology and equipment relative to the mixing of the concrete paste and the aggregates.

16. A concrete structure formed according to the process of claim 1.
